(19) United States
(12) Patent Application Publication
(10) Pub. No.: US 2025/0375640 A1
(43) Pub. Date: Dec. 11, 2025

(54) FIRE EXTINGUISHING WATER DISCHARGE DEVICE OPERATED BY WATER PRESSURE

(71) Applicant: KOREA INSTITUTE OF OCEAN SCIENCE & TECHNOLOGY, Busan (KR)

(72) Inventors: Young Shik KIM, Daejeon (KR); Hyung Won SHIM, Sejong-si (KR); Hyun Seok KIM, Sejong-si (KR)

(73) Assignee: KOREA INSTITUTE OF OCEAN SCIENCE & TECHNOLOGY, Busan (KR)

(21) Appl. No.: 19/228,202

(22) Filed: Jun. 4, 2025

(30) Foreign Application Priority Data
Jun. 5, 2024 (KR) 10-2024-0073645

(51) Int. Cl. A62C 31/00; A62C 27/00

(52) U.S. Cl. CPC A62C 31/005; A62C 27/00

(57) ABSTRACT

A fire extinguishing water discharge device includes a support part in which a plurality of support pieces are arranged at intervals in the front-rear direction; a fire extinguishing water discharge part hingedly coupled to any one of the support pieces of the support part and having a plurality of nozzles arranged at intervals on its upper surface; a first driving unit connected between one end of any one of the support pieces and one end of the other, and provided with a plurality of wheels in contact with the ground at one side; a second driving unit connected between the other end of any one of the support pieces and the other end of the other, and provided with a plurality of wheels in contact with the ground at one side; and a control part spaced from the support part and configured to control the flow of fire extinguishing water.

### CROSS REFERENCE TO RELATED APPLICATION

The present application claims priority to Korean Patent Application No. 10-2024-0073645 filed on Jun. 5, 2024, the entire contents of which are incorporated herein for all purposes by this reference.

### BACKGROUND

### Technical Field

The present invention relates to a fire extinguishing water discharge device, and more specifically, to a fire extinguishing water discharge device operated by water pressure. This device not only reduces the inconvenience and cost burden of having to prepare a separate driving apparatus for activation, but also allows the direction of water discharge to be changed. Therefore, it is possible to discharge extinguishing water in accordance with the location of the fire on a vehicle, allowing for smoother fire suppression.

### Description of Related Technology

In general, conventional vehicles are driven by internal combustion engines, which cause problems such as air pollution due to exhaust gases.

For this reason, electric vehicles (EVs) have recently gained attention.

Electric vehicles are powered by motors using electricity supplied from batteries, which means they do not emit exhaust gases, thus preventing air pollution. Additionally, they produce minimal noise while driving, reducing driver fatigue, and have fewer parts, allowing for lower maintenance costs. As a result, they are rapidly replacing traditional internal combustion engine vehicles.

However, electric vehicles have the disadvantage of being difficult to extinguish once a fire breaks out.

That is, when a fire occurs in the battery pack of an electric vehicle due to external impacts or internal short circuits, it is difficult to extinguish in the early stages due to phenomena such as thermal runaway. As a result, the fire may spread to nearby vehicles, increasing the extent of fire damage.

This issue becomes more serious when electric vehicles are transported by ship, as the vehicles are densely packed to maximize space utilization. If a fire breaks out in one vehicle, it can quickly spread to surrounding vehicles, amplifying the damage.

On the other hand, most fires in electric vehicles are suppressed using fire extinguishing water discharge devices, such as the one disclosed in Korean Patent Publication No. 10-2023-0146361.

However, conventional fire extinguishing water discharge devices only discharge water forward, making it difficult to effectively deliver water to the battery pack, which is typically located at the bottom of an electric vehicle. This makes fire suppression particularly difficult when the battery pack is involved.

In addition, most conventional fire extinguishing water discharge devices are manually pushed or pulled by an operator, which makes movement to the fire site cumbersome and poses a safety risk to the operator.

To address this, some fire extinguishing devices are equipped with separate driving apparatuses such as motors.

However, these devices come with their own issues, such as the inconvenience and cost burden of having to prepare a separate driving unit.

For the reasons above, there is a growing demand in the field for a fire extinguishing water discharge device that can operate smoothly without requiring a separate driving unit and can adjust the discharge direction based on the fire location on a vehicle. However, a satisfactory solution has not yet been developed.

### PRIOR ART LITERATURE

### Patent Document

Korean Patent Publication No. 10-2023-0146361

### SUMMARY

The present invention has been proposed to solve the problems of the conventional art as described above, and aims to provide a fire extinguishing water spraying apparatus that can be activated smoothly without a separate driving device and that allows fire extinguishing water to be sprayed in response to the location of the fire outbreak point in a vehicle.

In order to achieve the above objective, the present invention provides: a support unit in which a plurality of support pieces are arranged at intervals in the front and rear directions; a fire extinguishing water spraying unit that is hingedly coupled to one of the support pieces of the support unit, and in which a plurality of nozzles are arranged at intervals on the upper surface; a first driving unit that is connected between one end of one support piece of the support unit and one end of the other support piece, and in which a plurality of wheels contacting the ground are provided on one side; a second driving unit that is connected between the other end of one support piece of the support unit and the other end of the other support piece, and in which a plurality of wheels contacting the ground are provided on one side; and a control unit that is spaced from the support unit, with one end connected to a fire hydrant, and which controls the flow of fire extinguishing water in each of: a first fire extinguishing water supply pipe that extends to the fire extinguishing water spraying unit from the other end; a second fire extinguishing water supply pipe that extends to the first driving unit from the other end; and a third fire extinguishing water supply pipe that extends to the second driving unit from the other end; wherein the first driving unit and the second driving unit rotate their wheels by the hydraulic pressure caused by the flow of the fire extinguishing water supplied through the second and third fire extinguishing water supply pipes, respectively.

The fire extinguishing water spraying unit may include a rotation module that operates by the hydraulic pressure of fire extinguishing water supplied through the first fire extinguishing water supply pipe, and which is capable of reciprocating rotation within a certain angular range due to its operation.

The rotation module may be a cylinder in which a rod moves in and out by hydraulic pressure of the fire extinguishing water.

The wheels of the first and second driving units may include water turbines connected to their respective rotating shafts, and may rotate by the rotational force of the water turbines due to hydraulic pressure of the fire extinguishing water supplied through the second and third fire extinguishing water supply pipes.

The first and second driving units may include discharge ports for discharging the fire extinguishing water supplied through the second and third fire extinguishing water supply pipes to the outside.

The control unit may control the flow of fire extinguishing water in each of the first, second, and third fire extinguishing water supply pipes by opening and closing valves provided in each of the pipes.

At least one of the plurality of nozzles disposed in the fire extinguishing water spraying unit may be disposed on a drilling member that elevates and rotates by hydraulic pressure, and the elevating and rotating drilling member may form a hole in the bottom surface of an electric vehicle where a fire has occurred, thereby directly injecting fire extinguishing water into a battery pack mounted on the bottom surface of the electric vehicle.

The present invention may further include: a camera disposed on one of the support unit or the fire extinguishing water spraying unit for capturing images ahead; and a monitor disposed in the control unit for displaying images captured by the camera.

The fire extinguishing water spraying apparatus driven by hydraulic pressure according to the present invention includes a first driving unit and a second driving unit having a plurality of wheels that contact the ground, wherein the wheels of the first and second driving units rotate by hydraulic pressure caused by the internal flow of fire extinguishing water supplied through the second and third fire extinguishing water supply pipes. Therefore, since the apparatus can be activated without a separate driving device by the rotation of the wheels of the first and second driving units due to hydraulic pressure, the inconvenience and cost associated with providing a separate driving device for activation can be reduced.

The fire extinguishing water spraying apparatus driven by hydraulic pressure according to the present invention includes a fire extinguishing water spraying unit having a rotation module that operates by the hydraulic pressure of fire extinguishing water supplied through the first fire extinguishing water supply pipe, and the rotation module is capable of reciprocating rotation within a certain angular range. Therefore, since it can spray fire extinguishing water while in a lying or standing state, particularly by spraying water upward when in a lying state, fire extinguishing water can be effectively delivered to a battery pack located on the bottom surface of an electric vehicle where the fire has occurred, making it effective for suppressing fires in electric vehicles.

### BRIEF DESCRIPTION OF THE DRAWINGS

FIG. 1 is a schematic view of the fire extinguishing water discharge device operated by water pressure according to the present invention.

FIG. 2 is an exemplary view showing the activation of the fire extinguishing water discharge device operated by water pressure according to the present invention.

FIG. 3 is an exemplary view showing the wheel rotation of the first driving unit and the second driving unit in the fire extinguishing water discharge device operated by water pressure according to the present invention.

FIG. 4 is an exemplary view showing a form of water discharge through the fire extinguishing water discharge unit in the fire extinguishing water discharge device operated by water pressure according to the present invention.

FIG. 5 is an exemplary view showing another form of water discharge through the fire extinguishing water discharge unit in the fire extinguishing water discharge device operated by water pressure according to the present invention.

FIG. 6 is an exemplary view showing the operation of the rotation module of the fire extinguishing water discharge unit in the fire extinguishing water discharge device operated by water pressure according to the present invention.

### DETAILED DESCRIPTION

Hereinafter, a detailed description of the present invention based on the accompanying drawings is as follows.

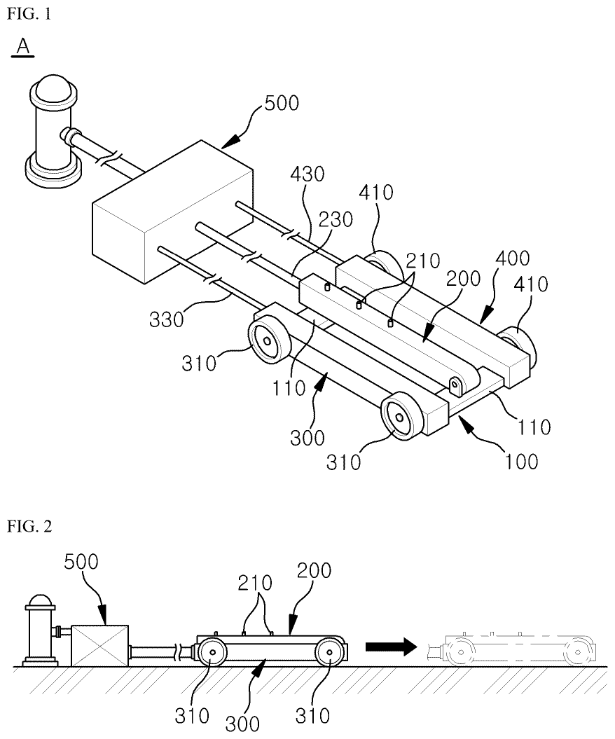

As shown in FIG. 1, a fire extinguishing water discharge device operated by water pressure A according to the present invention includes a support part 100; a fire extinguishing water discharge part 200; a first operating part 300; a second operating part 400; and a control part 500.

The support part 100 of the present invention includes a plurality of support plates 110 arranged at intervals in the front and rear directions.

Therefore, by the support plates 110, support of the fire extinguishing water discharge part 200, the first operating part 300, and the second operating part 400 can be made.

Such the support part 100 only supports the fire extinguishing water discharge part 200, the first operating part 300, and the second operating part 400 through the support plates 110 and does not have any other special functions; therefore, a detailed description of the support part 100 is omitted.

The fire extinguishing water discharge part 200 of the present invention includes a plurality of nozzles 210 arranged at intervals in the longitudinal direction on the upper surface.

Therefore, the fire extinguishing water introduced into the fire extinguishing water discharge part 200 can be discharged externally through the plurality of nozzles 210.

Such the fire extinguishing water discharge part 200 is hinge-coupled to any one of the support plates 110 of the support part 100, so that rotation of the fire extinguishing water discharge part 200 on the support part 100 can be performed.

At this time, the fire extinguishing water discharge part 200 includes a rotation module 220 so that rotation can be performed by operation of the rotation module 220.

Here, the rotation module 220 can operate by the water pressure action of the fire extinguishing water supplied through a first fire extinguishing water supply pipe 230 described below.

In other words, the rotation module 220 may be a cylinder (not shown) in which a rod (not shown) is moved in and out by the water pressure action of the fire extinguishing water, and by connecting the tip of the rod moved in and out by the water pressure action to the fire extinguishing water discharge part 200, the fire extinguishing water discharge part 200 can rotate forward and backward within a certain angular range by the rod movement due to the water pressure action.

Meanwhile, the rotation module 220, more specifically the cylinder, is connected with a branch pipe 231 branched from the first fire extinguishing water supply pipe 230, so that the rod movement in and out can be performed by the water pressure action when a portion of the fire extinguishing water flowing along the first fire extinguishing water supply pipe 230 flows through the branch pipe 231.

At this time, the flow of fire extinguishing water through the branch pipe 231 can be controlled by the control part 500.

In other words, a valve (not shown) provided in the branch pipe 231 can be opened and closed by the control part 500, thereby controlling the intermittent flow of fire extinguishing water through the branch pipe 231.

In addition, at least one of the plurality of nozzles 210 of the fire extinguishing water discharge part 200 is arranged with a drilling member (not shown) that ascends, descends, and rotates by the water pressure action, and as the drilling member ascends, descends, and rotates to form a hole in the bottom surface of an electric vehicle (not shown) where fire occurs, direct spraying of fire extinguishing water onto a battery pack (not shown) mounted on the bottom surface of the electric vehicle can be performed.

The first operating part 300 of the present invention is connected and installed between one end of any one of the support plates 110 of the support part 100 and another end, and a plurality of wheels 310 contacting the ground are provided on one side.

Therefore, the movement of the fire extinguishing water discharge device A operated by water pressure according to the present invention can be performed by the rotation of the wheels 310 of the first operating part 300.

At this time, the wheels 310 of the first operating part 300 rotate by the water pressure action according to the flow of fire extinguishing water within the first operating part 300.

In other words, a water turbine 311 is connected to the rotation shaft (not shown) of the wheels 310 of the first operating part 300, so that the rotation of the water turbine 311 by the water pressure action of the fire extinguishing water supplied through a second fire extinguishing water supply pipe 330 described below causes the wheels 310 to rotate, thereby enabling the movement of the fire extinguishing water discharge device A operated by water pressure according to the present invention without a separate driving device.

Meanwhile, the first operating part 300 includes a discharge port 320, so that the fire extinguishing water supplied through the second fire extinguishing water supply pipe 330 can be discharged externally through the discharge port 320, allowing continuous flow of fire extinguishing water within the first operating part 300 while the supply through the second fire extinguishing water supply pipe 330 proceeds, thereby continuously enabling the rotation of the water turbine 311 and the wheels 310 connected thereto.

The second operating part 400 of the present invention is connected and installed between one end of any one of the support plates 110 of the support part 100 and another end, and a plurality of wheels 410 contacting the ground are provided on one side.

Therefore, the movement of the fire extinguishing water discharge device A operated by water pressure according to the present invention can be performed by the rotation of the wheels 410 of the second operating part 400.

At this time, the wheels 410 of the second operating part 400 rotate by the water pressure action according to the flow of fire extinguishing water within the second operating part 400.

In other words, a water turbine 411 is connected to the rotation shaft (not shown) of the wheels 410 of the second operating part 400, so that the rotation of the water turbine 411 by the water pressure action of the fire extinguishing water supplied through a third fire extinguishing water supply pipe 430 described below causes the wheels 410 to rotate, thereby enabling the movement of the fire extinguishing water discharge device A operated by water pressure according to the present invention without a separate driving device.

Meanwhile, the second operating part 400 includes a discharge port 420, so that the fire extinguishing water supplied through the third fire extinguishing water supply pipe 430 can be discharged externally through the discharge port 420, allowing continuous flow of fire extinguishing water within the second operating part 400 while the supply through the third fire extinguishing water supply pipe 430 proceeds, thereby continuously enabling the rotation of the water turbine 411 and the wheels 410 connected thereto.

The control part 500 of the present invention is spaced apart from the support part 100, connected at one end to a fire hydrant (not shown), and controls the flow of fire extinguishing water in the first fire extinguishing water supply pipe 230 extending from the other end to the fire extinguishing water discharge part 200, the second fire extinguishing water supply pipe 330 extending from the other end to the first operating part 300, and the third fire extinguishing water supply pipe 430 extending from the other end to the second operating part 400, respectively.

Therefore, by controlling the flow of fire extinguishing water by the control part 500, unintended discharge of fire extinguishing water from the fire extinguishing water discharge part 200 can be prevented, as well as unintended rotation of the wheels 310 and 410 in the first operating part 300 and the second operating part 400 can be prevented.

At this time, the control part 500 can control the flow of fire extinguishing water in each of the first fire extinguishing water supply pipe 230, the second fire extinguishing water supply pipe 330, and the third fire extinguishing water supply pipe 430 through opening and closing of valves provided in each of the first fire extinguishing water supply pipe 230, the second fire extinguishing water supply pipe 330, and the third fire extinguishing water supply pipe 430.

Meanwhile, the control part 500 may be of any conventional structure and method as long as it can control the flow of fire extinguishing water in each of the first fire extinguishing water supply pipe 230, the second fire extinguishing water supply pipe 330, and the third fire extinguishing water supply pipe 430, and thus a detailed description of the control part 500 is omitted.

In addition, the fire extinguishing water discharge device A operated by water pressure according to the present invention may further include a camera (not shown) arranged on any one of the support part 100 and the fire extinguishing water discharge part 200; and a monitor (not shown) arranged in the control part 500 to display images captured by the camera.

Therefore, when the fire extinguishing water discharge device A operated by water pressure according to the present invention moves by remote control to suppress a fire, the images captured by the camera can be checked through the monitor to identify the front, particularly the flame source, thereby enabling movement toward the flame source and facilitating smooth discharge of fire extinguishing water toward the flame source.

At this time, since the control part 500 is provided with the monitor (not shown), the images captured by the camera are displayed on the monitor provided in the control part, allowing smooth confirmation of the images captured by the camera at the fire suppression site.

A detailed description regarding fire suppression using the fire extinguishing water discharge device A operated by water pressure according to the present invention is as follows.

The present invention includes a fire extinguishing water discharge part 200 in which a plurality of nozzles 210 are arranged at intervals on the upper surface, and one end of the fire extinguishing water discharge part 200 is connected to the first fire extinguishing water supply pipe 230, so that fire extinguishing water supplied from the first fire extinguishing water supply pipe 230 flows into the fire extinguishing water discharge part 200 and can be discharged externally through the plurality of nozzles 210.

Therefore, by applying the fire extinguishing water discharged through each nozzle 210 of the fire extinguishing water discharge part 200 to a vehicle where a fire has occurred, fire suppression can be achieved.

At this time, the fire extinguishing water discharge part 200 includes a rotation module 220 operated by the water pressure action of the fire extinguishing water supplied through the first fire extinguishing water supply pipe 230, and the rotation module 220 can rotate forward and backward within a certain angular range by its operation, allowing it to lie down or stand up, so that fire extinguishing water can be discharged forward or upward through each nozzle 210.

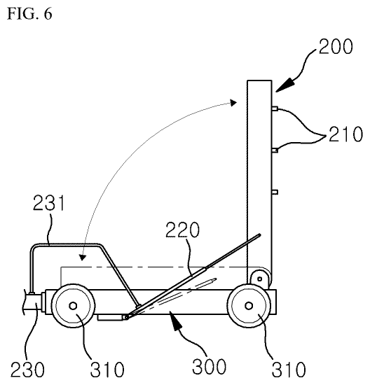

In other words, the rotation module 220 of the present invention may be a cylinder, as shown in FIG. 6, in which the rod moves in and out by the water pressure action of the fire extinguishing water, and by connecting the rod tip, which moves in and out by the water pressure action, to the fire extinguishing water discharge part 200, the fire extinguishing water discharge part 200 can rotate forward and backward within a certain angular range by the rod movement due to the water pressure action.

Here, the cylinder is connected with a branch pipe 231 branched from the first fire extinguishing water supply pipe 230, so that the rod movement in and out can be performed by the water pressure action when a portion of the fire extinguishing water flowing along the first fire extinguishing water supply pipe 230 flows through the branch pipe 231.

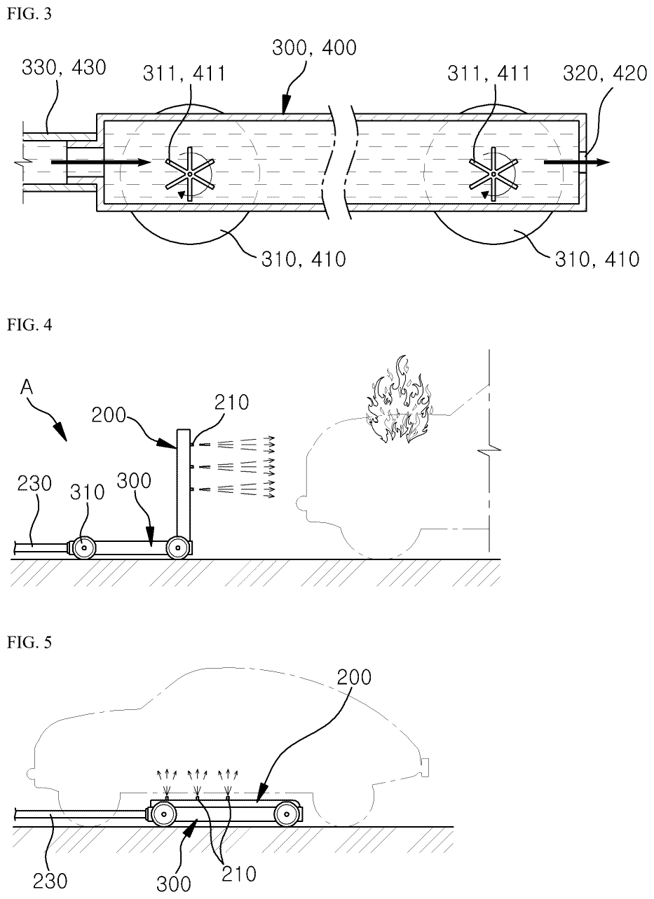

Therefore, when a fire occurs in a general vehicle (not shown), by discharging fire extinguishing water forward as shown in FIG. 4 from the front, rear, or side of the fire-occurring general vehicle, fire extinguishing water can be applied to the front, rear, or side of the respective vehicle end, so that fire suppression of the general vehicle can be smoothly performed. In particular, when a fire occurs in the battery pack of an electric vehicle, by discharging fire extinguishing water upward as shown in FIG. 5 while inserted under the fire-occurring electric vehicle, fire extinguishing water can be intensively applied to the battery pack located at the bottom of the electric vehicle, so that fire suppression of the electric vehicle can be smoothly performed.

However, during the fire suppression process, movement such as approach to the fire-occurring vehicle, in other words, operation, is required, which may cause inconvenience due to the movement.

However, the present invention includes a first operating part 300 and a second operating part 400, each provided with multiple wheels 310, 410 in contact with the ground on one side, so as shown in FIG. 2, each wheel 310, 410 of the first operating part 300 and the second operating part 400 rotates in contact with the ground, enabling easy operation, thereby reducing inconvenience caused by the operation.

At this time, the wheels 310, 410 of the first operating part 300 and the second operating part 400 rotate by the water pressure action due to the flow of fire extinguishing water inside supplied through the second fire extinguishing water supply pipe 330 and the third fire extinguishing water supply pipe 430, respectively. Therefore, operation can be performed without a separate driving device due to the rotation of the wheels 310, 410 of the first operating part 300 and the second operating part 400 by water pressure action, reducing the inconvenience and cost of providing a separate driving device for operation.

That is, turbines 311 and 411 are connected to the rotation shafts of each wheel 310 and 410 of the first operating part 300 and the second operating part 400, respectively. As shown in FIG. 3, the rotation of the turbines 311 and 411 caused by the water pressure action of the fire extinguishing water supplied through the second fire extinguishing water supply pipe 330 and the third fire extinguishing water supply pipe 430 causes the wheels 310 and 410 to rotate, so that the operation of the fire extinguishing water discharge device A operated by water pressure according to the present invention can be performed without a separate driving device.

Meanwhile, the flow of fire extinguishing water in the first fire extinguishing water supply pipe 230 leading to the fire extinguishing water discharge part 200, the second fire extinguishing water supply pipe 330 leading to the first operating part 300, and the third fire extinguishing water supply pipe 430 leading to the second operating part 400, respectively, is controlled by the control part 500. By controlling the fire extinguishing water flow by the control part 500, unintended discharge of fire extinguishing water from the fire extinguishing water discharge part 200 can be prevented, as well as unintended rotation of the wheels 310 and 410 in the first operating part 300 and the second operating part 400 can be prevented.

At this time, the control part 500 controls the flow of fire extinguishing water in each of the first fire extinguishing water supply pipe 230, the second fire extinguishing water supply pipe 330, and the third fire extinguishing water supply pipe 430 through opening and closing valves provided in each pipe. Thus, the control of fire extinguishing water flow in each of the first, second, and third fire extinguishing water supply pipes can be stably performed.

The present invention as described above is not limited to the embodiments described above, and may be modified within the scope that does not depart from the gist of the present invention as claimed in the claims. Such modifications are included within the scope of protection of the present invention defined by the claims below.

### DESCRIPTION OF REFERENCE NUMERALS

100: Support part
110: Support plate
200: Fire extinguishing water discharge part
210: Nozzle
220: Rotation module
230: First fire extinguishing water supply pipe
231: Branch pipe
300: First operating part
310: Wheel
311: Turbine
320: Discharge port
330: Second fire extinguishing water supply pipe
400: Second operating part
410: Wheel
411: Turbine
420: Discharge port
430: Third fire extinguishing water supply pipe
500: Control part
A: Fire extinguishing water discharge device

What is claimed is:

1. A fire extinguishing water discharge device operated by water pressure, comprising:
a support part in which a plurality of support plates are arranged at intervals in a front-rear direction;
a fire extinguishing water discharge part hingedly coupled to any one of the support plates of the support part, the fire extinguishing water discharge part having a plurality of nozzles arranged at intervals on an upper surface thereof;
a first driving unit connected between one end of any one of the support plates and one end of another support plate of the support part, the first driving unit being provided with a plurality of wheels on one side thereof in contact with a ground;
a second driving unit connected between the other end of any one of the support plates and the other end of another support plate of the support part, the second driving unit being provided with a plurality of wheels on one side thereof in contact with the ground; and
a control part spaced apart from the support part, one end of which is connected to a fire hydrant, the control part controlling water flow in each of a first fire extinguishing water supply pipe extending from the other end to the fire extinguishing water discharge part, a second fire extinguishing water supply pipe extending from the other end to the first driving unit, and a third fire extinguishing water supply pipe extending from the other end to the second driving unit,
wherein the wheels of the first driving unit and the second driving unit are rotated by a hydraulic force generated by water flowing inside through the second fire extinguishing water supply pipe and the third fire extinguishing water supply pipe.

2. The fire extinguishing water discharge device operated by water pressure according to claim 1,
wherein the fire extinguishing water discharge part includes a rotation module operated by hydraulic force of water supplied through the first fire extinguishing water supply pipe, and the rotation module performs forward and reverse rotation within a predetermined angular range.

3. The fire extinguishing water discharge device operated by water pressure according to claim 2,
wherein the rotation module is a cylinder in which a rod is extended and retracted by hydraulic force of the water.

4. The fire extinguishing water discharge device operated by water pressure according to claim 1,
wherein the wheels of the first driving unit and the second driving unit include respective water wheels connected to rotation shafts thereof, and the wheels are rotated by the water wheels rotated by hydraulic force of water supplied through the second fire extinguishing water supply pipe and the third fire extinguishing water supply pipe.

5. The fire extinguishing water discharge device operated by water pressure according to claim 1,
wherein the first driving unit and the second driving unit respectively include discharge ports for discharging the water supplied through the second fire extinguishing water supply pipe and the third fire extinguishing water supply pipe to an outside.

6. The fire extinguishing water discharge device operated by water pressure according to claim 1,
wherein the control part controls the flow of water in the first fire extinguishing water supply pipe, the second fire extinguishing water supply pipe, and the third fire extinguishing water supply pipe by opening and closing valves provided in each of the pipes.

7. The fire extinguishing water discharge device operated by water pressure according to claim 1,
wherein at least one of the plurality of nozzles disposed in the fire extinguishing water discharge part is disposed on a drilling member that moves vertically and rotates by hydraulic force, and the drilling member forms a hole in a bottom surface of an electric vehicle where fire has occurred, thereby allowing fire extinguishing water to be directly discharged onto a battery pack mounted on the bottom surface of the electric vehicle.

8. The fire extinguishing water discharge device operated by water pressure according to claim 1,
further comprising a camera disposed on either the support part or the fire extinguishing water discharge part to capture a frontward image, and a monitor disposed in the control part to display the image captured by the camera.
